(19) United States
(12) Patent Application Publication
(10) Pub. No.: US 2025/0225099 A1
(43) Pub. Date: Jul. 10, 2025

(54) Computer-Readable Media, Controllers, Control Devices, Methods, and Computer Programs for a Shared Device and Requester Devices

(71) Applicant: Intel Corporation, Santa Clara, CA (US)

(72) Inventors: Cong ZHANG, Shanghai (CN); Zhonghua SUN, Shanghai (CN); Jian WANG, Shanghai (CN); Zihan WU, Shanghai (CN); Wei YANG, Shanghai (CN); Xin ZHANG, Shanghai (CN); Di ZHANG, Shanghai (CN); Tao ZHAO, Shanghai (CN); Shuyan ZHAO, Shanghai (CN)

(21) Appl. No.: 19/093,336

(22) Filed: Mar. 28, 2025

(30) Foreign Application Priority Data
Apr. 11, 2024 (WO) PCT/CN2024/087407

(51) Int. Cl. G06F 13/42

(52) U.S. Cl. CPC G06F 13/4221; G06F 2213/0026

(57) ABSTRACT

Some aspects of the present disclosure relate to a non-transitory computer-readable medium storing instructions that, when executed by one or more processing circuitries, cause the one or more processing circuitries to perform a method for a controller of a shared device, the method comprising obtaining (130), from a requester device connected to the shared device via an interconnect fabric, a request for using a functionality of the shared device, and providing (140) access to the functionality of the shared device using a share of performance of the shared device defined by a data structure mapping one or more requester devices to one or more shares of performance of the shared device for the requester device.

### CROSS-REFERENCE TO RELATED APPLICATION

This application claims priority under 35 U.S.C. § 120 to International Application No. PCT/CN2024/087407, filed on Apr. 11, 2024, which designated the United States. The entirety of the prior application is incorporated herein by reference.

### BACKGROUND

An interconnect fabric is a network architecture that can be used to connect multiple components such as CPUs (Central Processing Units), memory, and peripheral devices, as well as multiple hosts together, allowing them to communicate with each other. It typically comprises multiple pathways and switches to manage data traffic efficiently. Compared to a simple interconnect bus, an interconnect fabric usually offers multiple parallel paths and more scalability and bandwidth, whereas a bus is more limited in parallel transmissions and expansion capabilities.

Intel® CXL (Computer eXpress Link) fabric, introduced in CXL Specification 3.0, provides refined mechanisms for memory pooling by enabling a highly scalable memory resource accessible to all hosts and peer devices. In previous iterations, memory pools were time division shared, owned by only one host during given time-slot A, and owned by another host during time-slot B. The CXL fabric introduces shared memory devices denoted as GFD (Global Fabric Attached Memory Device), allowing multiple hosts and peer devices to access the shared memory simultaneously. One CXL fabric can support up to 4096 ports, so that thousands of hosts can share one block of CXL memory.

For example, such a shared memory can be used to train or perform inference on a Large Language Model (LLM). The emergence of large language models (LLMs) has increased the parameter size of AI models to a massive scale, which results in higher demands with respect to accessing computer memory. The achievement of low latency and high bandwidth for memory access across GPUs is crucial for LLM training performance. A uniform and shared memory can improve both the training performance and accuracy of models on various tasks and domains.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of a controller or control device for a shared device, the shared device comprising such a controller, and a system;

FIG. 1b shows a flow chart of an example of a method for a controller of a shared device;

FIG. 2 shows a schematic diagram of a memory block being shared by a shared device to multiple hosts;

FIG. 3 shows an example of port-based memory bandwidth allocation;

FIG. 4 shows an overview of an example of a controller for a shared device;

FIG. 5a shows an example table for CXL FM (Fabric Manager) API (Application Programming Interface) command operation codes for a controller (PBMBA, Port Based Memory Bandwidth Memory Allocation) for a shared device;

FIG. 5b shows an example table of a payload for a Get PBMBA allocated BW (Bandwidth) request;

FIG. 5c shows an example table of a payload for a Get PBMBA allocated BW response;

FIG. 5d shows an example table of a payload for a Set PBMBA allocated BW request and response;

FIG. 5e shows an example table for _DSM (CXL root device specific methods) definitions for a CXL root device;

FIG. 5f shows an example table for _DSM for retrieving PBMBA (inputs and outputs);

FIG. 6 shows a schematic diagram of an Fabric Manager (FM) workflow;

FIG. 7a shows a schematic diagram of an example of controller or control device for a requester device, a requester device comprising such a controller, and a system;

FIG. 7b shows a flow chart of an example of a method for a requester device; and

FIG. 8 shows a flow chart of an example of a workflow for reporting an allocated bandwidth to OSPM (Operating System-directed configuration and Power Management) using a _DSM.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

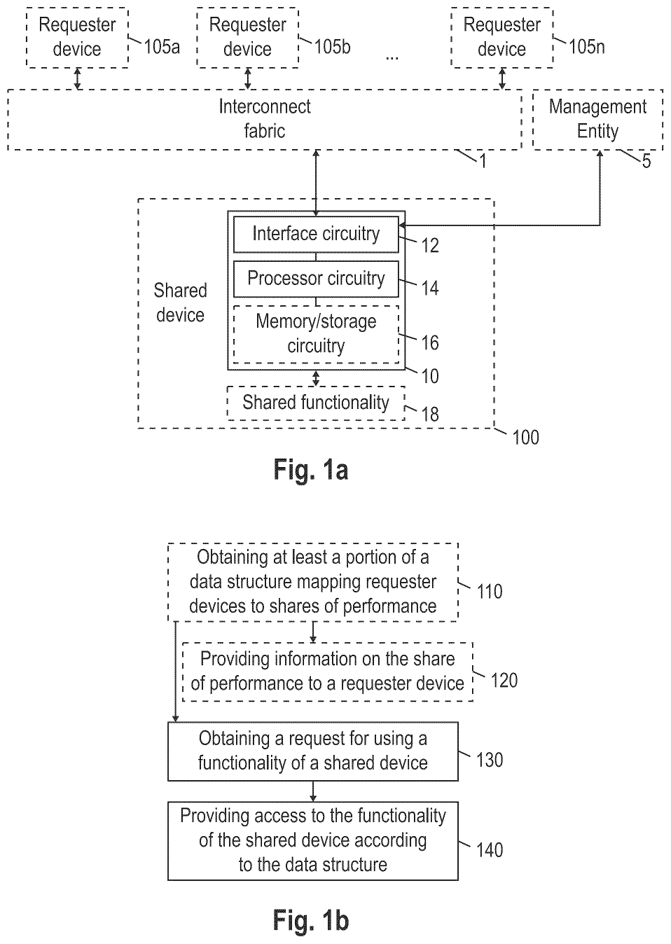

FIG. 1a shows a schematic diagram of an example of a controller 10 or control device 10 for a shared device 100, i.e., a device 100 being used, in a shared manner, by one or more requester devices 105a-105n. The controller 10 comprises circuitry to provide the functionality of the controller 10. For example, the circuitry of the controller 10 may be configured to provide the functionality of the controller 10. For example, the controller 10 of FIG. 1a comprises interface circuitry 12, processor circuitry 14, and (optional) memory/storage circuitry 16. For example, the processor circuitry 14 may be coupled with the interface circuitry 12 and/or the memory/storage circuitry 16. For example, the processor circuitry 14 may provide the functionality of the controller, in conjunction with the interface circuitry 12 (for communicating with other entities inside or outside the shared device 100, e.g., with one or more requester devices 105a-105n and/or with a management entity 5, in particular via interface fabric 1), and the memory/storage circuitry 16 (for storing information, such as machine-readable instructions). Likewise, the control device 10 may comprise means for providing the functionality of the control device 10. For example, the means may be configured to provide the functionality of the control device 10. The components of the control device 10 are defined as component means, which may correspond to or be implemented by the respective structural components of the controller 10. For example, the control device 10 of FIG. 1a comprises means for processing 14, which may correspond to or be implemented by the processor circuitry 14, means for communicating 12, which may correspond to or be implemented by the interface circuitry 12, and (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The controller 10 or control device 10 may comprise the machine-readable instructions, e.g., within the memory or storage circuitry 16 or means for storing information 16.

FIG. 1a further shows the shared device 100 comprising the controller 10 or control device 10. FIG. 1a further shows a system comprising the shared device 100 and one or more requester devices 105a-105n. For example, the system may further comprise the management entity 5 and/or the interconnect fabric 1.

The processor circuitry 14 or means for processing 14 is to obtain, from a requester device 105a, 105b, 105n connected to the shared device 100 via the interconnect fabric 1, a request for using a functionality of the shared device. The processor circuitry 14 or means for processing 14 is to provide access to the functionality of the shared device using a share of performance of the shared device defined by a data structure mapping one or more requester devices to one or more shares of performance of the shared device for the requester device.

FIG. 1b shows a flow chart of an example of a corresponding method for a controller of the shared device 100. The method comprises obtaining 130, from the requester device 105a, 105b, 105n connected to the shared device 100 via the interconnect fabric 1, the request for using a functionality of the shared device. The method comprises providing 140 access to the functionality of the shared device using the share of performance of the shared device defined by the data structure mapping one or more requester devices to one or more shares of performance of the shared device for the requester device.

In the following, the features of the controller 10, control apparatus 10 and shared device 100 of FIG. 1a as well as the features of the corresponding method of FIG. 1b are discussed in connection with the controller 10 or shared device 100 of FIG. 1a. Features introduced in connection with the controller 10 or shared device 100 of FIG. 1a may likewise be included in the corresponding control device 10 and method.

The proposed concept relates a shared device providing access to its functionality for one or more requester devices 105a-105n via an interconnect fabric. In computer architecture, a shared device that provides functionality that is accessible simultaneously by multiple hosts, such as the requester devices 105a-105n, is often also referred to as a “shared resource” or “shared functionality” There are various types of shared resources/functionalities. One typical example of a shared resource is shared memory. For example, shared memory allows different processes or systems (hosts) to communicate and access the same data space concurrently, facilitating efficient inter-process communication and data sharing. Accordingly, the shared device may be a shared memory device. Thus, the shared functionality/resource may be a shared memory functionality/resource. In this case, the share of performance (being provided for the requester device) may comprise at least one of a read bandwidth and a write bandwidth for accessing the shared memory. This way, access to the shared memory may be provided with a pre-set Quality of Service.

There are other types of shared functionalities/resources. For example, the shared device may be a shared accelerator device, such as a shared AI (Artificial Intelligence) accelerator, or a shared General-Purpose Graphics Processing Unit accelerator. A shared accelerator is a form of specialized hardware designed to perform specific tasks more efficiently than general-purpose processors (e.g., CPUs). Shared accelerator devices can serve multiple requester devices and workloads, thereby improving resource usage and performance. For example, an AI accelerator may be a type of shared accelerator that specializes in processing artificial intelligence and machine learning algorithms. An AI accelerator may provide improved performance for operations such as matrix multiplications and neural network computations, enabling faster training and inference times compared to traditional CPUs or GPUs. A General-Purpose Graphics Processing Unit (GPGPU) can serve as a shared accelerator by leveraging its parallel processing capabilities to handle multiple computational tasks in parallel. In the case of shared accelerator devices, the functionality may thus be computation acceleration functionality. To provide a share of the performance of the respective accelerator device to the shared accelerator device, a fixed portion of the resources (e.g., a fixed portion of the memory, or a fixed share of computation cores) of the respective accelerator device may be reserved for the accelerator device. Thus, the share of performance may be at least one of a share of memory or a share of computation cores. This way, access to the shared accelerator device may be provided with a pre-set Quality of Service.

Another type of shared devices are shared networking devices. In networking, much of the functionality is offloaded from the hosts to the network interface card (NIC), which performs encoding/decoding of the network packets, traffic management, error correction, and sometimes even encryption/decryption, thereby reducing the computational load on the hosts. In the proposed concept, a networking device, such as a network interface card (NIC), may be used as shared device among requester devices. Accordingly, the functionality may be a networking functionality, and the share of performance may comprise at least one of a share of uplink bandwidth or a share of downlink bandwidth. This way, access to the shared networking device may be provided with a pre-set Quality of Service.

It is evident from the above examples that the share of performance is not necessarily a single value. For example, in the case of shared accelerator devices, the amount of memory and the number of computational cores may be set separately by the share of performance. Similarly, in the case of shared memory, the write performance and the read performance may be set separately. In the case of a shared networking device, the uplink/input bandwidth and the downlink/output bandwidth may be set separately. In other words, the data structure mapping one or more requester devices to one or more shares of performance of the shared device may comprise separate entries for two or more aspects of performance, such as write performance and read performance, output performance and input performance, uplink bandwidth and downlink bandwidth, or amount of memory and number of computational cores. This way, the QoS can be provided in a more targeted manner, allowing for improved utilization of the shared device.

In general, it may be desirable to avoid introducing delays or overhead when attempting to achieve the proposed QoS functionality. Therefore, determining the share of performance for the requester device may be performed at improved efficiency by looking up the corresponding share of performance in the data structure (which may be kept in memory by the controller 10). A simple, fast and unique lookup can be provided based on an identifier of the requester device being contained in the request. In other words, the processor circuitry 14 may determine the share of performance for the requester device based on an identifier of the requester device. To improve the lookup times, the identifier may be kept short. As the identifier is merely used to distinguish between requester devices that are able to access the shared device via the interconnect fabric, the interconnect fabric ports assigned to the respective requester devices may be used as their identifiers. In other words, the identifier of the requester device may be a source identifier being used for port-based routing.

In a straightforward implementation, the controller 10 may manage and/or determine the data structure without requiring input by a management entity 5, e.g., by determining the data structure, e.g., equally based on the number of requester devices having access to the shared device. To further improve the QoS by taking into account the needs of the respective requester devices, the data structure may be provided or managed (at least partially) by an operator or orchestrator via management entity 5. In other words, the processor circuitry 14 may obtain at least a portion of the data structure mapping the one or more requester devices to the one or more shares of performance of the shared device from the management entity 5. Similarly, with respect to the method of FIG. 1b, the method may comprise obtaining 110 at least a portion of the data structure mapping the one or more requester devices to the one or more shares of performance of the shared device from the management entity 5. For example, in CXL Fabric, the Fabric Manager (FM) may be such a management entity.

Moreover, in general, requester devices may show improved performance if they know the level of performance they can expect from the shared device. For example, the requester devices may adjust cache sizes, pipelining structure etc. based on the share of performance they have access to. Therefore, information on the share of performance may be provided to the requester devices, e.g., to a controller 70 of the respective requester devices. For example, the processor circuitry 14 may provide information on the share of performance to the requester device. Accordingly, with respect to the method of FIG. 1b, the method may comprise providing 120 information on the share of performance to the requester device.

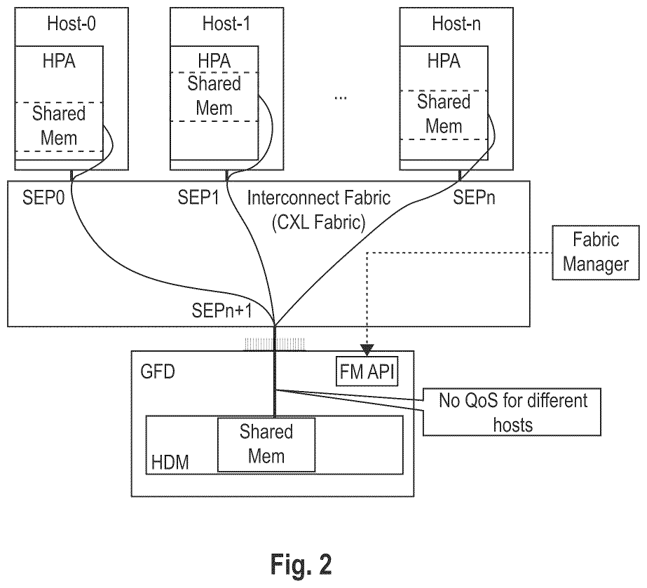

The proposed concept is applicable to various types of interconnect fabrics that can be used for host-to-host communication, such as Intel® Compute express Link (CXL), interconnect fabric, Nvidia NVLink, or InfiniBand. In the examples given with respect to FIGS. 2 to 6 and 8, the interconnect fabric is a CXL interconnect fabric. Accordingly, the request may be obtained via the CXL interconnect fabric.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a Field-Programmable Gate Array (FPGA), such as a FPGA implementing processor or (micro-) controller logic, a micro-controller, etc. For example, on an FPGA, a microcontroller design can be programmed and isolated from tenant designs that then can use the microcontroller as if the microcontroller was a discrete microcontroller. In this case, the FPGA-based microcontroller may comprise the processor circuitry or means for processing 14, the interface circuitry or means for communicating 12, and/or the memory or storage circuitry/means for storing information 16.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), such as static Random Access Memory of an FPGA, block Random Access Memory of an FPGA, distributed Random Access Memory of an FPGA, Programmable Read Only Memory (PROM), Erasable Programmable Read Only Memory (EPROM), an Electronically Erasable Programmable Read Only Memory (EEPROM), or a network storage.

More details and aspects of the controller 10, control device 10, shared device 100 and the corresponding method are mentioned in connection with the proposed concept or one or more examples described above or below (e.g. FIGS. 2 to 8). The controller 10, control device 10, shared device 100 and the corresponding method may comprise one or more additional optional features corresponding to one or more aspects of the proposed concept or one or more examples described above or below.

In the following, an example is provided for accessing a shared memory device (GFD, Global Fabric Attached Memory Device) that is accessed via CXL. However, the concept and mechanisms shown in connection with FIGS. 2 to 6 and 8 can likewise be applied to other types of shared devices and other types of interconnect fabric.

FIGS. 2 to 6 and 8 relate to a mechanism of Port Based Memory Bandwidth Allocation (PBMBA) for CXL Shared Memory Quality of Service (QOS) among hosts.

FIG. 2 shows a schematic diagram of a memory block being shared by a shared device (shared memory device GFD) with multiple hosts. In particular, a CXL Shared Memory region block in GFD is shared to multiple hosts. When one or several hosts take too much bandwidth of the GFD, other hosts are impacted, even when they need to transmit data with higher priority. The proposed concept provides a mechanism to limit the maximum bandwidth for accessing shared memory per host to ensure that there is no significant throughput blocker when multiple (e.g., thousands) of hosts are working simultaneously.

The present disclosure proposes a mechanism of Port Based Memory Bandwidth Allocation (PBMBA) for CXL Shared Memory, to improve CXL Quality of Service (QOS) in the CXL fabric system among hosts. Since QoS among hosts is not considered in the CXL Fabric, there might not be a mechanism to provide a QoS mechanism for multi-host access to the CXL shared memory (or other shared devices). Other platforms may leverage existing mechanisms such as SLD (System Level Data)/MLD (Memory Level Data) CXL QoS and I/O RDT (Input/Output Resource Director Technology) to provide cache I/O devices or channels. CXL SLD/MLD QOS is a mechanism that enables the management of memory QoS for Type 2 and Type 3 CXL devices with heterogeneous memory media by reporting the device workload to the host with a system software command set. I/O RDT, which extends Intel® RDT, is a set of features that allows the monitoring and control of I/O device resources in the Intel® architecture by assigning resources to different threads or channels using RMID (Remote Memory Identifiers) and CLOS (Cache-Linked Occupancy Sensitive) concepts. The resource distribution technology may utilize the above mechanisms depending on the device type.

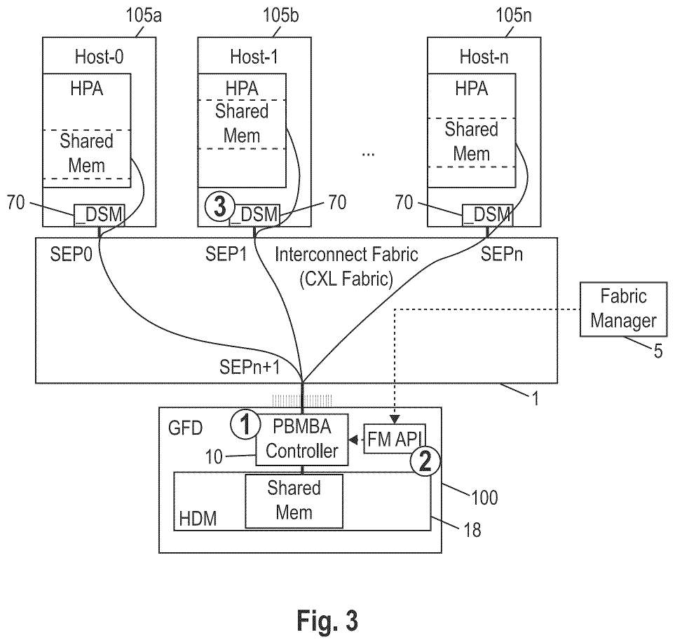

In the proposed concept, as shown in FIG. 3, a mechanism of Port Based Memory Bandwidth Memory Allocation (PBMBA) among different hosts is provided. FIG. 3 shows an example of port-based memory bandwidth allocation. As shown in FIG. 3, Hosts (requester devices) 105a-105n access shared memory device GFD 100 via CXL fabric 1. Each host 105a-105n is connected to the CXL fabric 1 via a corresponding port SEP0-SEPn, while GFD 100 is connected to the CXL fabric 1 via port SEPn+1. A fabric manager 5 (as management entity) is connected to GFD 100 via the CXL fabric 1. The GFD includes a PBMBA controller 10 (1) and an Fabric Manager API (Application Programming Interface) endpoint (2). Each host includes a HPA (Huge Page Allocator) onto which a portion of the shared memory 18 of the GFD is mapped. Each host also includes a _DSM (CXL Root Device Specific Methods) function (3). The components highlighted with (1), (2) and (3) have been added or modified as compared to FIG. 2.

The proposed concept provides (1) a PBMBA controller (e.g., controller 10 or control device 10 of FIG. 1a). The controller is a programmable request rate control controller, used (in this example), to control the memory bandwidth according to CXL Source Port Based Routing (PBR) ID (as requester device identifier), and can be programmed via an FM API command.

Various examples of the proposed concept further provide (2) FM API commands. New Fabric Manager API commands are proposed to support PBMBA controller programming to limit bandwidth (or other shares of performance) to shared memory access (or other shared device access) for each host.

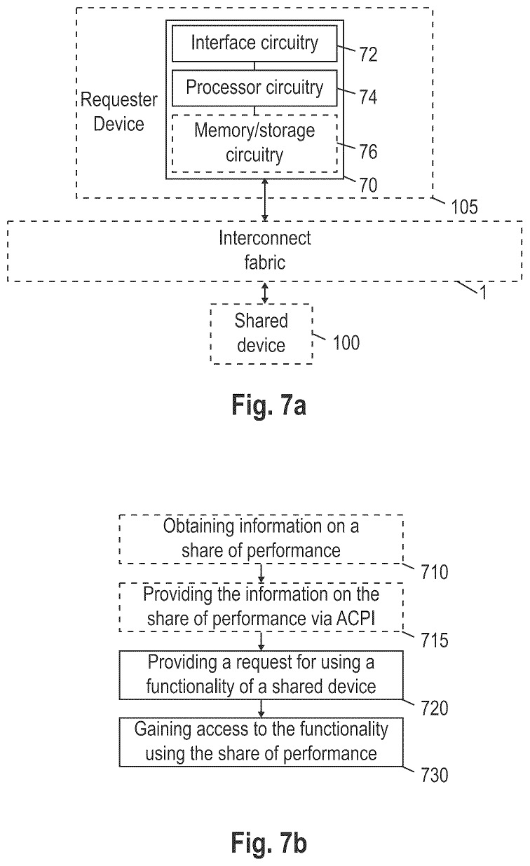

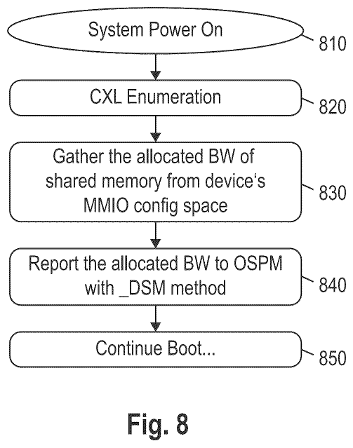

As discussed in connection with FIGS. 7a to 8, various examples of the proposed concept further provide a CXL ACPI (Advanced Configuration and Power Interface)_DSM Method. For example, a new function may be included in the _DSM method to report the allocated shared memory access bandwidth (or other share of performance) to OSPM through BIOS. As further discussed in connection with FIGS. 7a to 8, various examples of the proposed concept may further provide a BIOS and FM workflow incorporating the above components to implement PBMBA.

System managers can implement this new mechanism of PBMBA for CXL Shared Memory (or other shared devices) to establish Quality of Service (QOS) for hosts. It can accommodate thousands of hosts sharing memory (or other functionality) at the same time and without any significant throughput blocker. The PBMBA mechanism can support not only a (static) initial configuration, but also dynamic configuration, which can be well adapted to the load changes caused by system manager switching workloads.

According to the proposed concept, in a usage scenario where multiple hosts share a memory pool (or other functionality) via a CXL fabric, the bandwidth of a host (requester device) accessing the specified GFD (or other shared device) through the CXL Root Port may be limited to a certain range, even if the workload of this host increases significantly. Moreover, the proposed concept may provide an ACPI_DSM method that reports the PBMBA function via BIOS to OSPM. The Fabric Manager API command and_DSM method in the CXL Specification may be updated for PBMBA support.

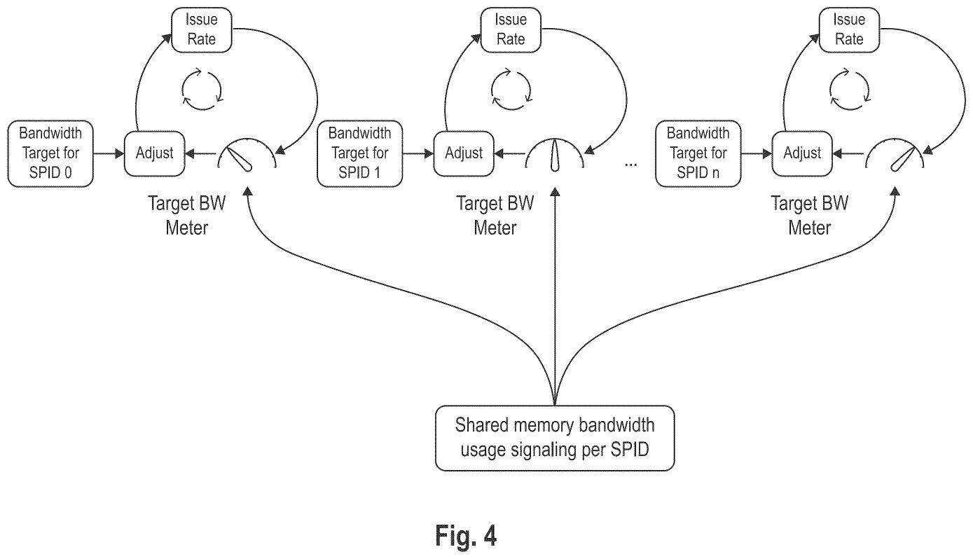

The proposed mechanism proposes a new component (the PBMBA Controller 10) to implement shared memory access bandwidth throttling to different hosts. FIG. 4 shows an overview of an example of a PBMBA Controller 10 for a shared device 100. In FIG. 4, the CXL Subordinate Port ID (SPID) is used as a basis for shared memory bandwidth usage signaling. For each SPID representing a host/requester device, a bandwidth target for the SPID as well as information of a target bandwidth meter are used as inputs for an adjustment function for the host, with the adjustment function issuing a rate for the port associated with the SPID.

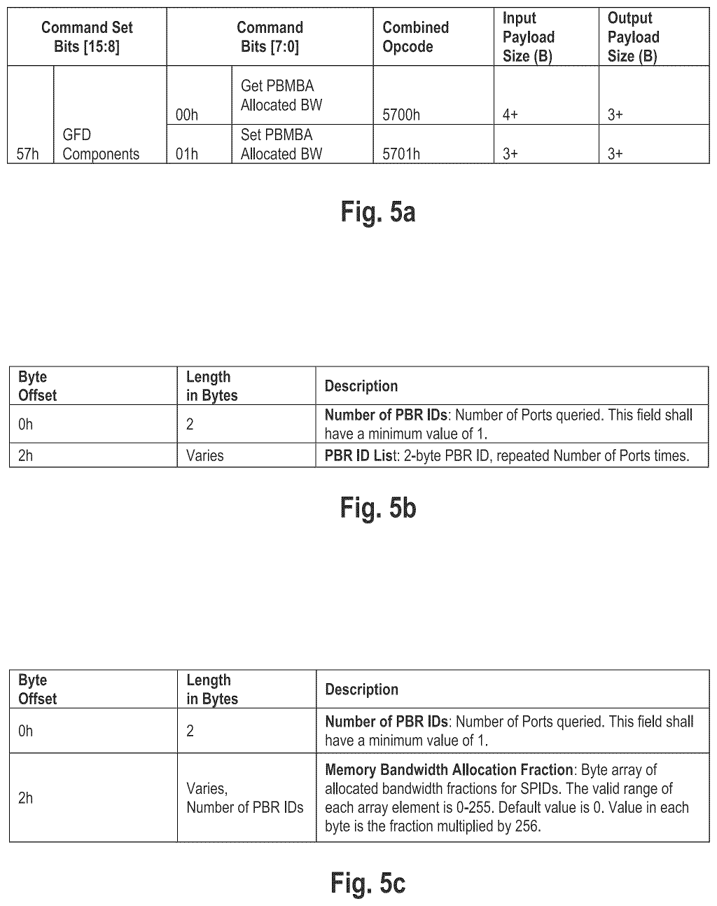

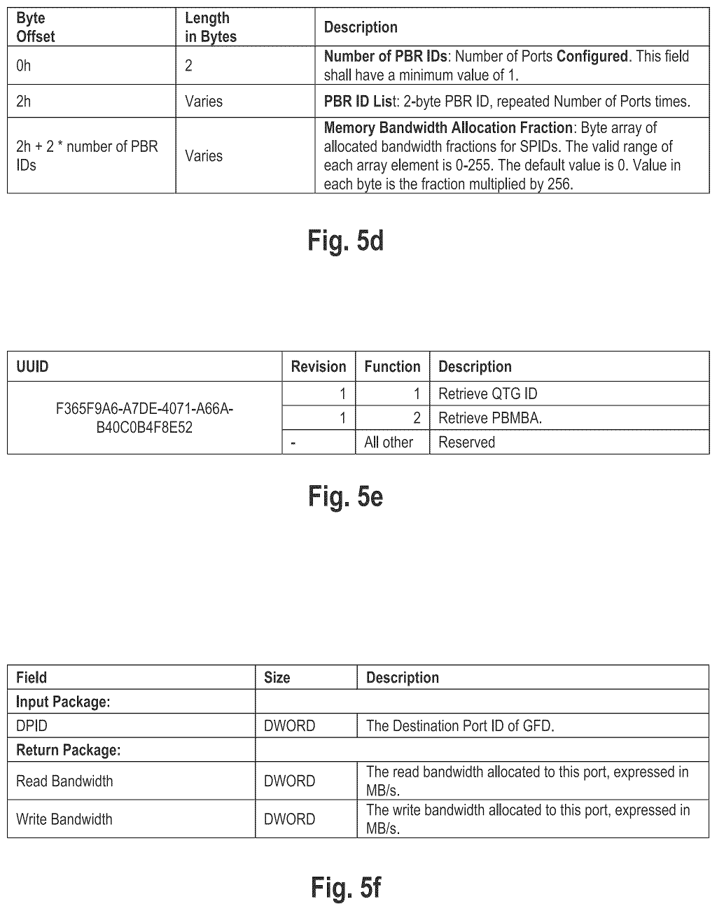

Various examples of the present disclosure may defined a new FM API command to configure the PBMBA Controller. FIG. 5a shows an example table for CXL FM (Fabric Manager) API (Application Programming Interface) command operation codes for a controller (PBMBA controller) for a shared (memory) device. The table defines two commands: Get PBMBA Allocated BW (Opcode 5700h) and Set PBMBA Allocated BW (Opcode 5701h).

FIG. 5b shows an example table of a payload for the Get PBMBA allocated BW (Bandwidth) request. It includes the number of Port-Based Routing Identifiers (PBR IDs, which is the number of ports queried), having a minimum value of 1, and the list of PRB-IDs (2 bytes per PBR ID, multiplied by the number of ports).

FIG. 5c shows an example table of a payload for a Get PBMBA allocated BW response. It includes the number of Port-Based Routing Identifiers (PBR IDs, which is the number of ports queried), having a minimum value of 1, and the memory bandwidth allocation fraction as a byte array of allocated bandwidth fractions for SPIDs. The valid range of each array element may be 0-255, with a default value being 0. The value in each byte may represent the fraction multiplied by 256.

FIG. 5d shows an example table of a payload for a Set PBMBA allocated BW (Opcode 5701h) request and response. The payload includes the number of PBR IDs of the number of ports configured, having a minimum value of 1, the PBR ID List: 2-byte PBR ID, repeated Number of Ports times, and the memory bandwidth allocation fraction as byte array of allocated bandwidth fractions for SPIDs. The valid range of each array element may be 0-255, with the default value being 0. The value in each byte may represent the fraction multiplied by 256.

In various examples, the proposed mechanism adds a new CXL Root Device Specific Methods (_DSM) function of Retrieve PBMBA for OSPM, to obtain the allocated bandwidth of the DPID (Device Physical ID). FIG. 5e shows an example table for _DSM (CXL root device specific methods) definitions for a CXL root device. The added function is in the second content row (Revision: 1, Function: 2, Retrieve PBMBA). The Retrieve PBMBA function is used to return the allocated bandwidth of the DPID. The function details are shown in FIG. 5f. FIG. 5f shows an example table for _DSM for retrieving PBMBA (inputs and outputs). The input package contains the field DPID (of size double word), containing the destination port ID of the GFD. The return package contains the read bandwidth (of size double word), representing the read bandwidth allocated to this port, expressed in MB/s, and the write bandwidth (of size double word), representing the write bandwidth allocated to this port, expressed in MB/s.

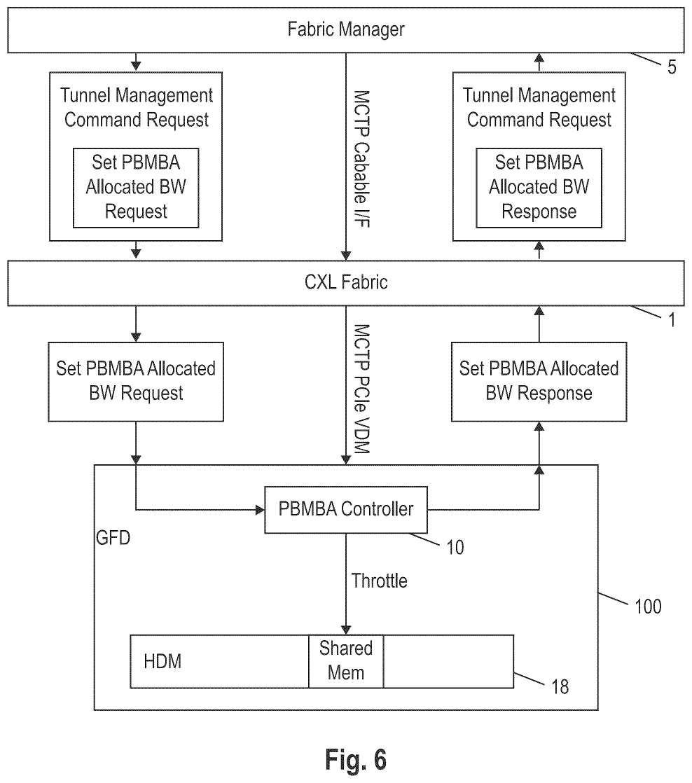

The CXL devices with PBMBA support can be configured statically or dynamically via the Fabric Manager (FM), an external logical process that queries and configures the system's operational state using the PBMBA FM commands defined above. FIG. 6 shows a schematic diagram of an example Fabric Manager (FM) workflow. In the workflow, the FM 5 sends a tunnel management command request comprising a Set PBMBA Allocated BW Request to the CXL Fabric 1 (using a Management Component Transport Protocol (MCTP) capable interface), where the Set PBMBA Allocated BW Request is forwarded to the PBMBA Controller 10 of GFD 100 (using an MCTP Peripheral Connect Interface express Vendor-Defined Message). The PBMBA Controller 10 is used to throttle access to the Shared Memory of the GFD based on the Set PBMBA Allocated BW Request. It provides a Set PBMBA Allocated BW Response to the CXL Fabric 1, where it is included in a Tunnel Management Command Request and provided back to the Fabric Manager.

More details and aspects of the PBMBA controller and associated mechanisms are mentioned in connection with the proposed concept or one or more examples described above or below (e.g., FIGS. 1a to 1b, 7a to 8). The PBMBA controller and associated mechanisms may comprise one or more additional optional features corresponding to one or more aspects of the proposed concept or one or more examples described above or below.

FIG. 7a shows a schematic diagram of an example of controller 70 or control device 70 for a requester device 105 (e.g., 105a-105n, as shown in FIGS. 1a and 3), a requester device 105 comprising such a controller 70 or control device 70, and a system comprising the requester device 105 and a shared device 100 (and optionally an interconnect fabric 1). The controller 70 comprises circuitry to provide the functionality of the controller 70. For example, the circuitry of the controller 70 may be configured to provide the functionality of the controller 70. For example, the controller 70 of FIG. 7a comprises interface circuitry 72, processor circuitry 74, and (optional) memory/storage circuitry 76. For example, the processor circuitry 74 may be coupled with the interface circuitry 72 and/or with the memory/storage circuitry 76. For example, the processor circuitry 74 may provide the functionality of the controller, in conjunction with the interface circuitry 72 (for communicating with other entities inside or outside the shared device 70, e.g., with a shared device 100 via interface fabric 1), and the memory/storage circuitry 76 (for storing information, such as machine-readable instructions). Likewise, the control device 70 may comprise means for providing the functionality of the control device 70. For example, the means may be configured to provide the functionality of the control device 70. The components of the control device 70 are defined as component means, which may correspond to, or implemented by, the respective structural components of the controller 70. For example, the control device 70 of FIG. 7a comprises means for processing 74, which may correspond to or be implemented by the processor circuitry 74, means for communicating 72, which may correspond to or be implemented by the interface circuitry 72, (optional) means for storing information 76, which may correspond to or be implemented by the memory or storage circuitry 76. In general, the functionality of the processor circuitry 74 or means for processing 74 may be implemented by the processor circuitry 74 or means for processing 74 executing machine-readable instructions. Accordingly, any feature ascribed to the processor circuitry 74 or means for processing 74 may be defined by one or more instructions of a plurality of machine-readable instructions. The controller 70 or control device 70 may comprise the machine-readable instructions, e.g., within the memory or storage circuitry 76 or means for storing information 76.

The processor circuitry 74 or means for processing 74 is to provide, to a shared device 100 connected to the requester device via the interconnect fabric 1, a request for using a functionality of the shared device. The processor circuitry 74 or means for processing 74 is to gain access to the functionality of the shared device using a share of performance of the shared device defined by a data structure mapping one or more requester devices to one or more shares of performance of the shared device for the requester device.

FIG. 7b shows a flow chart of an example of a corresponding method for the requester device 105. The method comprises providing 720, to the shared device connected to the requester device via the interconnect fabric, the request for using a functionality of the shared device. The method comprises gaining access 730 to the functionality of the shared device using the share of performance of the shared device defined by the data structure mapping one or more requester devices to one or more shares of performance of the shared device for the requester device.

In the following, the features of the controller 70, control device 70 and requester device 105 of FIG. 7a as well as the features of the corresponding method of FIG. 7b are discussed in connection with the controller 70 or requester device 105 of FIG. 7a. Features introduced in connection with the controller 70 or requester device 105 of FIG. 7a may likewise be included in the corresponding control device 70 and method.

In connection with FIGS. 1a to 6, a controller has been introduced that controls the share of performance of a shared device that can be used by respective requester devices. This mechanism reflects on the requester devices as well: When a requester device transmits a request for using a functionality of the shared device, it gains access to the functionality of the shared device using the share of performance of the shared device defined by the data structure mapping one or more requester devices to one or more shares of performance of the shared device for the requester device. This share of performance is enforced by the controller 10 or control device 10 discussed in connection with FIGS. 1a to 6.

In general, the requester device 105 benefits from knowing the share of performance that it is assigned. Thus, the processor circuitry 14 may obtain information on the share of performance from the shared device 100. Accordingly, the method of FIG. 7b may comprise obtaining 710 information on the share of performance from the shared device 100. This information on the share of performance may comprise one or more numerical values or identifiers representing the share of performance assigned to the respective requester device. For example, as discussed in connection with FIGS. 1a and 1b, the information on the share of performance may comprise one or more of an identifier or numerical value representing a write performance assigned to the requester device, an identifier or numerical value representing a read performance assigned to the requester device, an identifier or numerical value representing an output performance assigned to the requester device, an identifier or numerical value representing an input performance assigned to the requester device, an identifier or numerical value representing an uplink bandwidth assigned to the requester device, an identifier or numerical value representing a downlink bandwidth assigned to the requester device, an identifier or numerical value representing an amount of memory assigned to the requester device, or an identifier or numerical value representing a number of computation cores assigned to the requester device.

In general, the share of performance may already be known when the requester device boots and connects to the interconnect fabric. Therefore, the information on the share of performance may be obtained during enumeration of devices of the interconnect fabric, e.g., as part of CXL configuration. The respective data can then be provided via the ACPI. In other words, the processor circuitry may provide the information on the share of performance via the ACPI. Accordingly, the method of FIG. 7b may comprise providing 710 the information on the share of performance via the ACPI. An example of this mechanism is shown in FIG. 8.

FIG. 8 shows a flow chart of an example of a workflow for reporting an allocated bandwidth to OSPM (Operating System-directed configuration and Power Management) using a _DSM. When the system (requester device) powers on (810), CXL enumeration is performed (820), followed by gathering the allocated BW of shared memory (or other share of performance of a shared device) from the device's MMIO (Memory-Mapped Input/Output) configuration space (830) and reporting the allocated BW to OSPM using the _DSM method (840). Then the boot process continues (850). Thus, the system firmware (BIOS) in the host may report the allocated memory bandwidth to the shared memory (or other shares of performance of shared devices) using the _DSM ACPI method, which is associated with the CXL Root Device (HID=“ACPI0017”).

The interface circuitry 72 or means for communicating 72 may correspond to one or more inputs and/or outputs for receiving and/or transmitting information, which may be in digital (bit) values according to a specified code, within a module, between modules or between modules of different entities. For example, the interface circuitry 72 or means for communicating 72 may comprise circuitry configured to receive and/or transmit information.

For example, the processor circuitry 74 or means for processing 74 may be implemented using one or more processing units, one or more processing devices, any means for processing, such as a processor, a computer or a programmable hardware component being operable with accordingly adapted software. In other words, the described function of the processor circuitry 74 or means for processing may as well be implemented in software, which is then executed on one or more programmable hardware components. Such hardware components may comprise a general-purpose processor, a Digital Signal Processor (DSP), a Field-Programmable Gate Array (FPGA), such as a FPGA implementing processor or (micro-) controller logic, a micro-controller, etc. For example, on an FPGA, a microcontroller design can be programmed and isolated from tenant designs that then can use the microcontroller as if the microcontroller was a discrete microcontroller. In this case, the FPGA-based microcontroller may comprise the processor circuitry or means for processing 74, the interface circuitry or means for communicating 72, and/or the memory or storage circuitry/means for storing information 76.

For example, the memory or storage circuitry 76 or means for storing information 76 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), such as static Random Access Memory of an FPGA, block Random Access Memory of an FPGA, distributed Random Access Memory of an FPGA, Programmable Read Only Memory (PROM), Erasable Programmable Read Only Memory (EPROM), an Electronically Erasable Programmable Read Only Memory (EEPROM), or a network storage.

More details and aspects of the controller 70, control device 70, requester device 105 and corresponding method are mentioned in connection with the proposed concept or one or more examples described above or below (e.g. FIGS. 1a to 6). The controller 70, control device 70, requester device 105 and corresponding method may comprise one or more additional optional features corresponding to one or more aspects of the proposed concept or one or more examples described above or below.

In the following, some examples of the proposed concept are presented:

An example (e.g., example 1) relates to a non-transitory computer-readable medium storing instructions that, when executed by one or more processing circuitries, cause the one or more processing circuitries to perform a method for a controller of a shared device, the method comprising obtaining (130), from a requester device (105a, 105b, 105n) connected to the shared device (100) via an interconnect fabric (1), a request for using a functionality of the shared device, and providing (140) access to the functionality of the shared device using a share of performance of the shared device defined by a data structure mapping one or more requester devices to one or more shares of performance of the shared device for the requester device.

Another example (e.g., example 2) relates to a previous example (e.g., example 1) or to any other example, further comprising that the data structure mapping one or more requester devices to one or more shares of performance of the shared device comprises separate entries for output or write performance and input or read performance.

Another example (e.g., example 3) relates to a previous example (e.g., one of the examples 1 or 2) or to any other example, further comprising that the method comprises determining the share of performance for the requester device based on an identifier of the requester device.

Another example (e.g., example 4) relates to a previous example (e.g., example 3) or to any other example, further comprising that the identifier of the requester device is a source identifier being used for port-based routing.

Another example (e.g., example 5) relates to a previous example (e.g., one of the examples 1 to 4) or to any other example, further comprising that the method comprises obtaining (110) at least a portion of the data structure mapping the one or more requester devices to the one or more shares of performance of the shared device from a management entity (5).

Another example (e.g., example 6) relates to a previous example (e.g., one of the examples 1 to 5) or to any other example, further comprising that the method comprises providing (120) information on the share of performance to the requester device.

Another example (e.g., example 7) relates to a previous example (e.g., one of the examples 1 to 6) or to any other example, further comprising that the functionality is a shared memory functionality, with the share of performance comprising at least one of a read bandwidth and a write bandwidth.

Another example (e.g., example 8) relates to a previous example (e.g., one of the examples 1 to 7) or to any other example, further comprising that the functionality is an computation acceleration functionality, with the share of performance comprising at least one of a share of memory or a share of computation cores.

Another example (e.g., example 9) relates to a previous example (e.g., one of the examples 1 to 8) or to any other example, further comprising that the functionality is a networking functionality, with the share of performance comprising at least one of a share of uplink bandwidth or a share of downlink bandwidth.

Another example (e.g., example 10) relates to a previous example (e.g., one of the examples 1 to 9) or to any other example, further comprising that the request is obtained via a Compute eXpress Link, CXL, interconnect fabric.

An example (e.g., example 11) relates to a controller (10) for a shared device (100), the controller comprising interface circuitry (12) for communicating with requester devices via an interconnect fabric (1), machine-readable instructions, and processor circuitry (14) to execute the machine-readable instructions to obtain, from a requester device (105a, 105b, 105n) connected to the shared device (100) via the interconnect fabric (1), a request for using a functionality of the shared device, and provide access to the functionality of the shared device using a share of performance of the shared device defined by a data structure mapping one or more requester devices to one or more shares of performance of the shared device for the requester device.

An example (e.g., example 12) relates to a control device (10) for a shared device (100), the controller comprising means (12) for communicating with requester devices via an interconnect fabric (1), machine-readable instructions, and means for processing (14) to obtain, from a requester device (105a, 105b, 105n) connected to the shared device (100) via the interconnect fabric (1), a request for using a functionality of the shared device, and provide access to the functionality of the shared device using a share of performance of the shared device defined by a data structure mapping one or more requester devices to one or more shares of performance of the shared device for the requester device.

Another example (e.g., example 13) relates to a shared device (100) comprising the controller (10) or control device (10) according to example 11 or example 12.

Another example (e.g., example 14) relates to a previous example (e.g., example 13) or to any other example, further comprising that the shared device is a shared memory device.

Another example (e.g., example 15) relates to a previous example (e.g., example 13) or to any other example, further comprising that the shared device is a shared accelerator device.

Another example (e.g., example 16) relates to a previous example (e.g., example 13) or to any other example, further comprising that the shared device is a shared networking device.

An example (e.g., example 17) relates to a method for a controller of a shared device, the method comprising Obtaining (130), from a requester device (105a, 105b, 105n) connected to the shared device via an interconnect fabric (1), a request for using a functionality of the shared device, and providing (140) access to the functionality of the shared device using a share of performance of the shared device defined by a data structure mapping one or more requester devices to one or more shares of performance of the shared device for the requester device.

Another example (e.g., example 18) relates to a computer program having a program code for performing the method of example 17, when the computer program is executed on a computer, a processor, or a programmable hardware component.

An example (e.g., example 19) relates to a non-transitory computer-readable medium storing instructions that, when executed by one or more processing circuitries, cause the one or more processing circuitries to perform a method for a requester device, the method comprising providing (720), to a shared device connected to the requester device via an interconnect fabric, a request for using a functionality of the shared device, and gaining access (730) to the functionality of the shared device using a share of performance of the shared device defined by a data structure mapping one or more requester devices to one or more shares of performance of the shared device for the requester device.

Another example (e.g., example 20) relates to a previous example (e.g., example 19) or to any other example, further comprising that the method comprises obtaining (710) information on the share of performance from the shared device.

Another example (e.g., example 21) relates to a previous example (e.g., one of the examples 19 or 20) or to any other example, further comprising that the information on the share of performance is obtained during enumeration of devices of the interconnect fabric.

Another example (e.g., example 22) relates to a previous example (e.g., one of the examples 19 to 21) or to any other example, further comprising that the method comprises providing the information on the share of performance via an Advanced Configuration and Power Interface, ACPI.

An example (e.g., example 23) relates to a controller (70) for a requester device (105, 105a, 105b, 105n), the controller comprising interface circuitry (72) for communicating with a shared device via an interconnect fabric (1), machine-readable instructions, and processor circuitry (74) to execute the machine-readable instructions to provide, to a shared device (100) connected to the requester device via the interconnect fabric (1), a request for using a functionality of the shared device, and gain access to the functionality of the shared device using a share of performance of the shared device defined by a data structure mapping one or more requester devices to one or more shares of performance of the shared device for the requester device.

An example (e.g., example 24) relates to a control device (70) for a requester device (105, 105a, 105b, 105n), the controller comprising means (72) for communicating with a shared device via an interconnect fabric (1), machine-readable instructions, and means for processing (74) to provide, to a shared device (100) connected to the requester device via the interconnect fabric (1), a request for using a functionality of the shared device, and gain access to the functionality of the shared device using a share of performance of the shared device defined by a data structure mapping one or more requester devices to one or more shares of performance of the shared device for the requester device.

Another example (e.g., example 25) relates to a requester device (105, 105a, 105b, 105n) comprising the controller (70) or control device (70) according to example 23 or example 24.

An example (e.g., example 26) relates to a method for a requester device, the method comprising providing (720), to a shared device connected to the requester device via an interconnect fabric, a request for using a functionality of the shared device, and gaining access (730) to the functionality of the shared device using a share of performance of the shared device defined by a data structure mapping one or more requester devices to one or more shares of performance of the shared device for the requester device.

Another example (e.g., example 27) relates to a computer program having a program code for performing the method of example 26, when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a controller of a shared device, the method comprising:
obtaining, from a requester device connected to the shared device via an interconnect fabric, a request for using a functionality of the shared device; and
providing access to the functionality of the shared device using a share of performance of the shared device defined by a data structure mapping one or more requester devices to one or more shares of performance of the shared device for the requester device.

2. The non-transitory computer-readable medium according to claim 1, wherein the data structure mapping one or more requester devices to one or more shares of performance of the shared device comprises separate entries for output or write performance and input or read performance.

3. The non-transitory computer-readable medium according to claim 1, wherein the method comprises determining the share of performance for the requester device based on an identifier of the requester device.

4. The non-transitory computer-readable medium according to claim 3, wherein the identifier of the requester device is a source identifier being used for port-based routing.

5. The non-transitory computer-readable medium according to claim 1, wherein the method comprises obtaining at least a portion of the data structure mapping the one or more requester devices to the one or more shares of performance of the shared device from a management entity.

6. The non-transitory computer-readable medium according to claim 1, wherein the method comprises providing information on the share of performance to the requester device.

7. The non-transitory computer-readable medium according to claim 1, wherein the functionality is a shared memory functionality, with the share of performance comprising at least one of a read bandwidth and a write bandwidth.

8. The non-transitory computer-readable medium according to claim 1, wherein the functionality is an computation acceleration functionality, with the share of performance comprising at least one of a share of memory or a share of computation cores.

9. The non-transitory computer-readable medium according to claim 1, wherein the functionality is a networking functionality, with the share of performance comprising at least one of a share of uplink bandwidth or a share of downlink bandwidth.

10. The non-transitory computer-readable medium according to claim 1, wherein the request is obtained via a Compute eXpress Link, CXL, interconnect fabric.

11. A controller for a shared device, the controller comprising:
interface circuitry for communicating with requester devices via an interconnect fabric;
machine-readable instructions; and
processor circuitry to execute the machine-readable instructions to:
obtain, from a requester device connected to the shared device via the interconnect fabric, a request for using a functionality of the shared device; and
provide access to the functionality of the shared device using a share of performance of the shared device defined by a data structure mapping one or more requester devices to one or more shares of performance of the shared device for the requester device.

12. A shared device comprising the controller according to claim 11.

13. The shared device according to claim 12, wherein the shared device is a shared memory device.

14. The shared device according to claim 12, wherein the shared device is a shared accelerator device.

15. The shared device according to claim 12, wherein the shared device is a shared networking device.

16. A non-transitory computer-readable medium storing instructions that, when executed by one or more processing circuitries, cause the one or more processing circuitries to perform a method for a requester device, the method comprising:
providing, to a shared device connected to the requester device via an interconnect fabric, a request for using a functionality of the shared device; and
gaining access to the functionality of the shared device using a share of performance of the shared device defined by a data structure mapping one or more requester devices to one or more shares of performance of the shared device for the requester device.

17. The non-transitory computer-readable medium according to claim 16, wherein the method comprises obtaining information on the share of performance from the shared device.

18. The non-transitory computer-readable medium according to claim 16, wherein the information on the share of performance is obtained during enumeration of devices of the interconnect fabric.

19. The non-transitory computer-readable medium according to claim 16, wherein the method comprises providing the information on the share of performance via an Advanced Configuration and Power Interface, ACPI.
